(19) United States
(12) Patent Application Publication
(10) Pub. No.: US 2006/0164594 A1
(43) Pub. Date: Jul. 27, 2006

(54) Swivel lens-locker for spectacle frames

(76) Inventor: Tony Xin Xiao, Chino, CA (US)

Correspondence Address: Raymond Y. Chan;Suite 128, 108 N. Ynez Ave., Monterey Park, CA, 91754, US

(21) Appl. No.: 11/104,983

(22) Filed: Apr. 12, 2005

Related U.S. Application Data
(60) Provisional application No. 60/647,118, filed on Jan. 25, 2005.

(51) Int. Cl. G02C 5/00

(52) U.S. Cl. 351/141

(57) ABSTRACT

A lens-locker for spectacle frame includes a lower portion having a screw and an upper portion having a hole for inserting a freely rotating locking nut, in which the locking nut is screwed into the screw of the lower portion. When the locking nut is rotated in clockwise (counterclockwise) direction, the frame becomes close; contrariwise, the frame becomes open, so that the lens is adapted to be removed or replaced. The limitation-tail and the limitation-stop prevent the lower portion taking apart from the upper portion as the frame is being opened.

### CROSS REFERENCE OF RELATED APPLICATION

This a regular application of a provisional application, having an application No. 60/647,118 and a filing date of Jan. 25, 2005.

### BACKGROUND OF THE PRESENT INVENTION

1. Field of Invention

The present invention relates to an apparatus which can be used in spectacle frames for locking lenses.

2. Description of Related Arts

A rim lock is one of very common components being used in spectacle frames today. For many years, a conventional rim locker (as shown in Fig. PRIOR ART (A) and (B)) is simply design with a screw connecting between an upper portion and a lower portion of rim locker. The upper portion works as a nut, when the screw is being tighten up, the lower portion comes close to the upper portion, so as to effectively lock the lens in the rim, but when the screw is being screwed out, the lower portion will not automatically separate apart from the upper portion because there is no thread on the lower portion. In general, the upper portion and the lower portion can be separated off until completely screw out. Therefore one of disadvantage on this design is the screw may easily get lost when the optician dispenses the glasses. The other disadvantage is during the dispensing, the optician may need to remove or replace the lenses several times before the work done, it increases possibility to misplace the thread of the screw to the thread of the upper portion, causing stripped on the component, so that the frame becomes defective. As we can find, there are some prior arts teach various methods for solving above problems. For example, the U.S. Pat. No. 6,227,666 B1 disclosed a break-away screw that permit the optician does not need to fully remove the screw out as the frame opens and allow a portion of the fastening member to be severed as the frame closes. Similarly the U.S. Pat. No. 6,273,564 B1 disclosed a cam mechanism and a latch for facilitating the opening and closing of the frame. Unfortunately, the break-away screw has disadvantage that can not repeat using in actual practice, and the cam mechanism could easily break if the lens being over cut. In order to solve those problems, the present invention creates a new method as recited below.

### SUMMARY OF THE PRESENT INVENTION

A main object of the present invention is to provide a mechanical apparatus which utilizes swivel locking nut to permit the frame to be opened without taking the screw apart, so that the lenses can be removed or replaced easily for preventing screws lose or strip during the dispensing of glasses.

Another object of the present invention is to provide a mechanical apparatus which swivel locking nut and a screw are separate components from the upper portion and the lower portion of the lens-locker, so that when the screw or the swivel locking nut is being striped, they can be replaced without damaging the frame itself.

Another object of the present invention is to provide a mechanical apparatus which swivel locking nut and a screw are being assembled to the lower of the lens-locker, and the upper portion of the lens-locker having an open side, so that the locking nut can be swung in or out to the upper portion of the lens-locker, therefore the upper portion and the lower portion of the lens-locker can be completely separated off without taking the screw apart from the locking nut.

These and other objectives, features, and advantages of the present invention will become apparent from the following detailed description, the accompanying drawings, and the appended claims.

### BRIEF DESCRIPTION OF THE DRAWINGS

Prior (A) and (B) are rear views of the spectacle frame indicating the basic components of conventional frame as well as the basic frame components of the present invention.

FIG. 1A is a rear view of the partial frame according to the first preferred embodiment of the present invention.

FIG. 1B is a top view of the partial frame according to the first preferred embodiment of the present invention.

FIG. 2 is a partially sectional view of the lens-locker according to the first preferred embodiment of the present invention.

FIG. 3 is a partially sectional view of the lens-locker which having a locking pin in the screw according to the first preferred embodiment of the present invention.

FIG. 4 is a partially sectional view of the lens-locker which having a limitation-tail extended from the upper portion and a limitation-stop in the lower portion according to the first preferred embodiment of the present invention.

FIG. 4B is a partially sectional view of the lens-locker which having a limitation-pin being inserted from the two step hole of the upper portion connected to the lower portion according to the first preferred embodiment of the present invention.

FIG. 5 is a partially sectional view of the lens-locker which the lens-locker is in maximum open position because the limitation-stop prevents limitation-tail taking apart each other according to the first preferred embodiment of the present invention.

FIG. 5B is a partially sectional view of the lens-locker which the lens-locker is in maximum open position because the second step hole obstructs the pin-head of the limitation-pin moving forward, so that to prevent the upper portion taking apart from the lower portion according to the first preferred embodiment of the present invention.

FIG. 6 is a perspective view of the partial frame which the lens-locker is in maximum open position because the limitation-stop prevents limitation-tail taking apart each other according to the first preferred embodiment of the present invention.

FIG. 7A is a rear view of the partial frame according to the second preferred embodiment of the present invention.

FIG. 7B is a top view of the partial frame according to the second preferred embodiment of the present invention.

FIG. 8 is a side view of the partial frame which the locking nut is in swing position according to the second preferred embodiment of the present invention.

FIG. 9 is a partially sectional view of the lens-locker which having a limitation-tail extended from the upper portion and a limitation-stop in the lower portion according to the third preferred embodiment of the present invention.

FIG. 9B is a partially sectional view of the lens-locker which having a limitation-pin being inserted from the two step hole of the lower portion connected to the upper portion according to the third preferred embodiment of the present invention.

### DETAILED DESCRIPTION OF THE PREFERRED EMBODIMENT

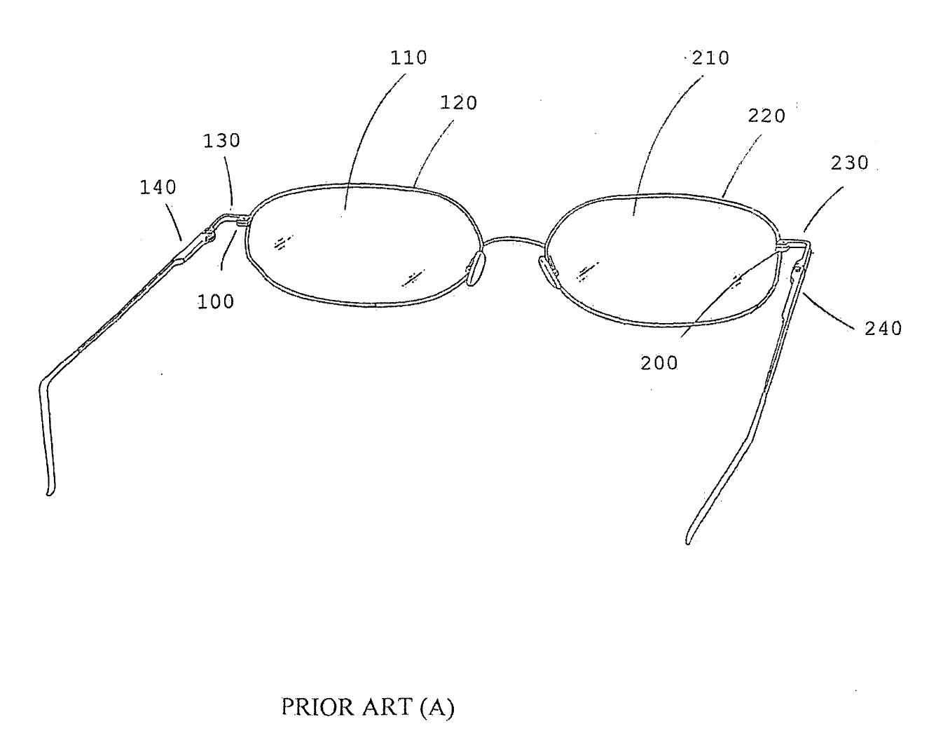

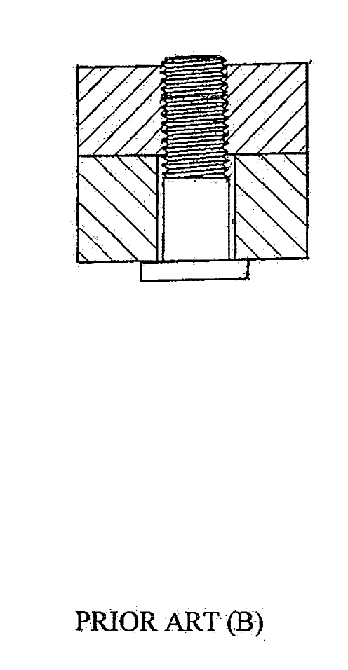

Referring to PRIOR ART(A), FIGS. 1A and 1B, of the drawing, a spectacle frame having a pair of lens-locker 100, 200 for locking a pair of lens 110, 210 in position, each lens-locker includes an upper portion 10 and a lower portion 20, which connected to an end of the upper rim 11 and an end of the lower rim 21 respectively, an end-piece 230 is connected to the outer side of the upper portion 10 of the lens-locker 200 and extended rearwardly for coupling with a temple 240.

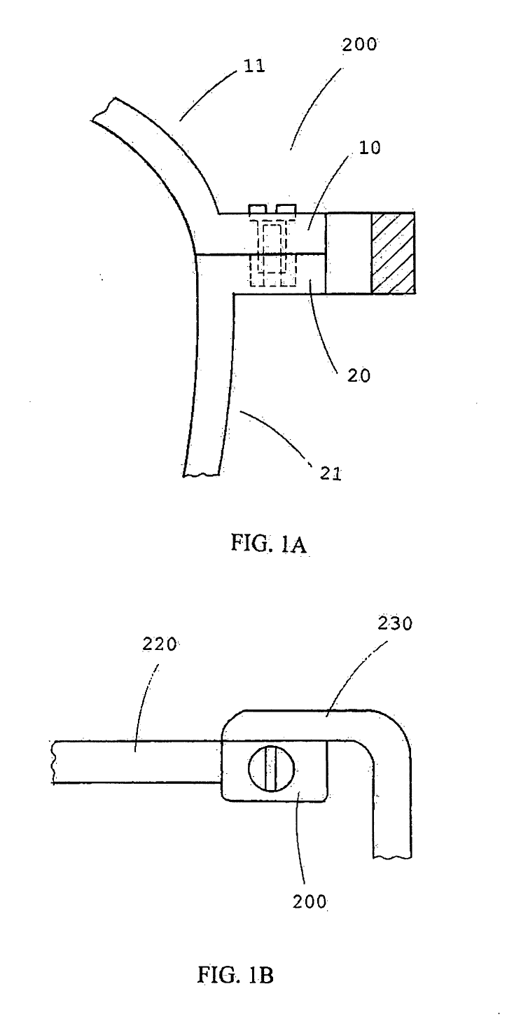

According to FIG. 2, the upper portion 10 has a hole 12 perpendicularly to the end-piece 230 as shown in FIG. 1B for inserting a swivel locking nut 30. The locking nut 30 includes a nut body 31 with interior thread and a nut head 32, the diameter of the nut body 31 is slightly smaller than the diameter of the hole 12 and the diameter of the nut head 32 is larger than the diameter of hole 12, so that the locking nut 30 can be rotated freely when the locking nut 30 has been inserted into the hole 12 of the upper portion 10 of the lens-locker 200. In addition, the nut body 31 is fastened by a limitation-washer 40 for preventing the locking nut 30 slides off from the upper portion 10 of the lens-locker 200. Further more, a screw 50 with exterior thread is connected to the lower portion 20 of the lens-locker 200 and has been screwed into the nut body 31. When the locking nut 30 is being gradually rotated in clockwise direction, the lower portion 20 will come close to the upper portion 10, so that the lens 210 can be securely locked as the locking nut 30 and the screw 50 is being tighten up. On the other hand, when the locking nut 30 is being gradually rotated in counterclockwise direction, the lower portion 20 and the upper portion 10 will separate away each other, so that the spectacle frame will be opened, therefore the lens can be easily removed or replaced.

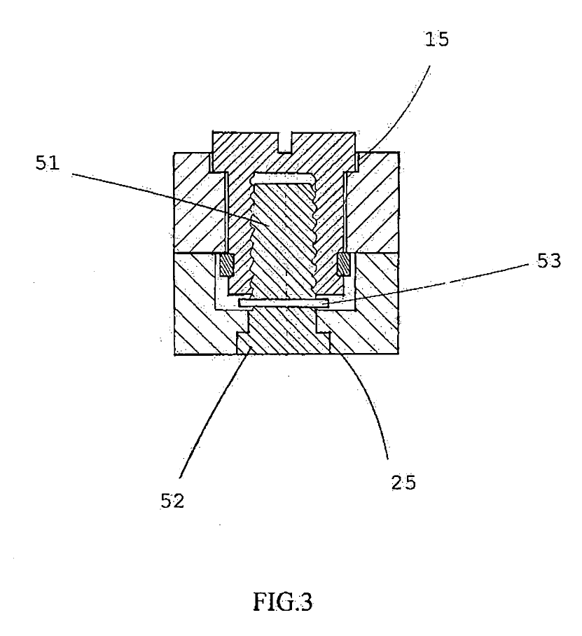

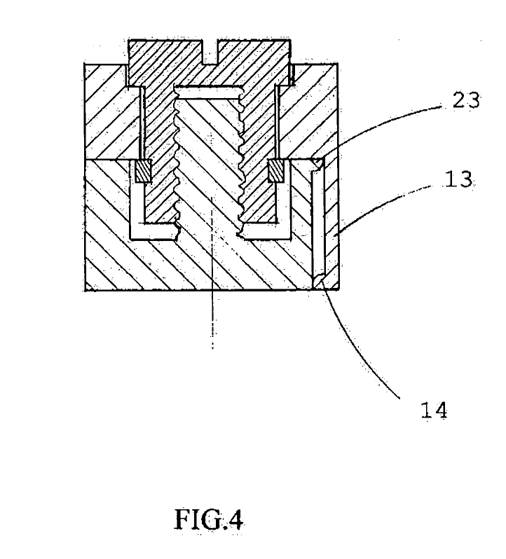

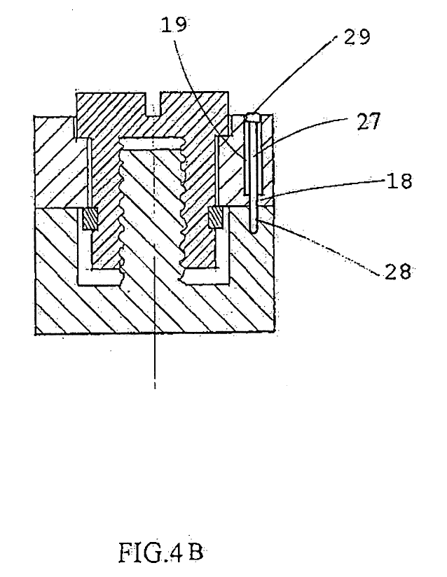

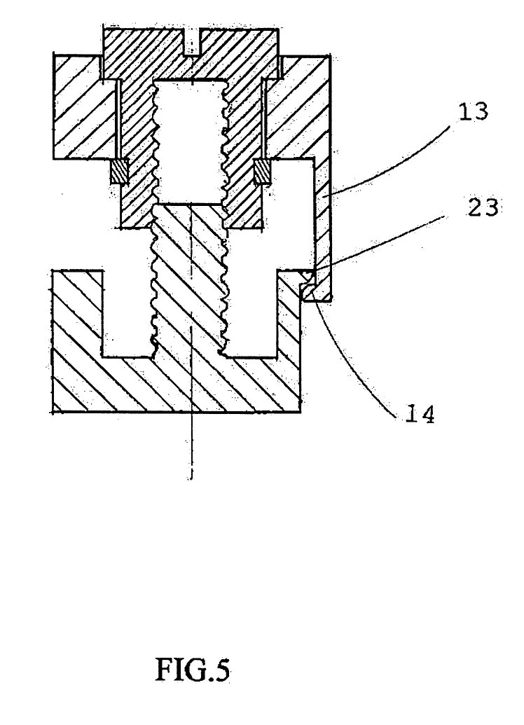

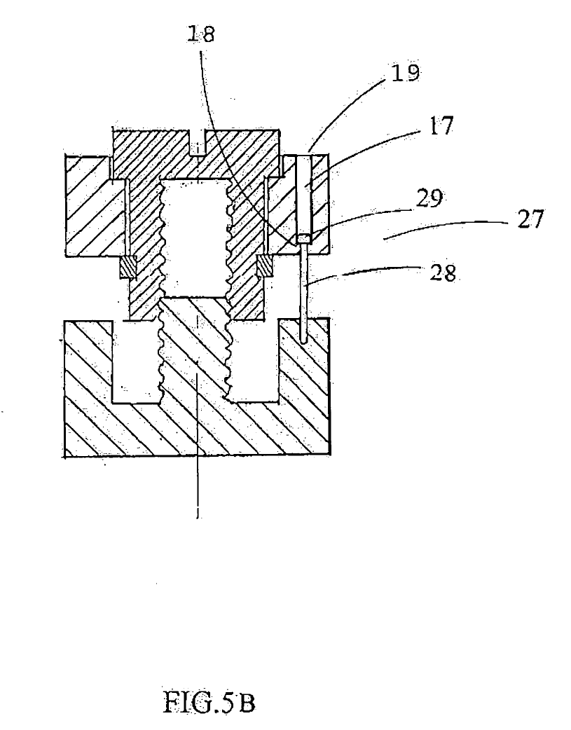

In order to prevent the screw 50 slides off from locking nut 30 during the above operation, a limitation-tail 13 of the upper portion 10 and a limitation-stop 23 of the lower portion 20 has been introduced in FIGS. 4 and 5. The limitation-tail 13 extended from the upper portion 10 toward the lower portion 20 with a hook 14. When the hook 14 has reached the limitation-stop 23 as the locking nut 30 being rotated in counterclockwise direction for rim opening, the limitation-stop 23 obstructs the lower portion 20 separate off from the upper portion 10. At this point in time, the spectacle frame is in maximum open position, which illustrates clearly in FIG. 6.

With a same concern to prevent the screw 50 slides off from locking nut 30 during the above operation, the other design may work well especially in actual production, which are shown in FIGS. 4B and 5B. The upper portion 10 further has a two-step hole 17 which includes a first step hold 19 and a second step hold 18 for inserting a limitation-pin 27. The limitation-pin 27 includes a pin-head 29 and a pin-body 28, in which the diameter of the pin-head 29 is slightly smaller than the diameter of the first step hole 19 and the diameter of the pin-body 28 is slightly smaller than the diameter of the second step hole 18, so that the limitation-pin 27 can go through the two-step hole 17 connected to the lower portion 20. When the lens-locker is being opening, the limitation-pin 27 can be moving through the two-step hole 27 until the pin-head 29 being stopped by the second-step hole 18, in which the lens-locker is in maximum open position.

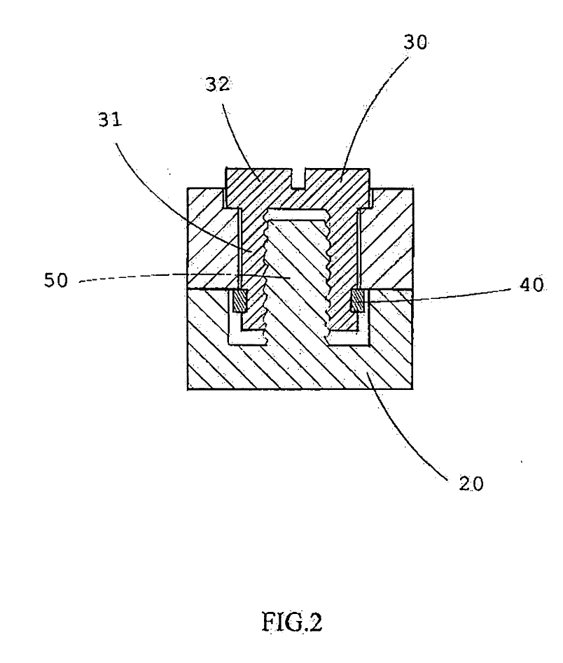

It is worth to mention that the screw 50 being connected to the lower portion 20 can be a separate component assembling with a locking pin 53 as shown in FIG. 3, which includes a screw body 51 and a screw head 52. The major advantage of this design is, if the screw 50 has been stripped, a new screw can be replaced easily without damaging the whole frame. For aesthetic purpose, the recesses 15, 25 have been formed on the outer side of the upper portion 10 as well as on the outer side of the lower portion 20 for concealing the nut head 32 and the screw head 52.

Detailed Description of the Second Preferred Embodiment

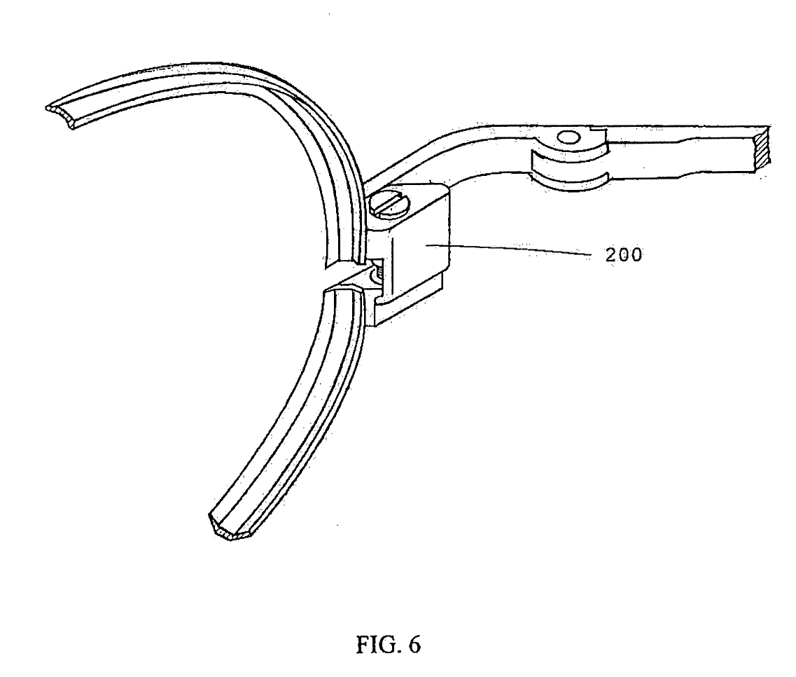

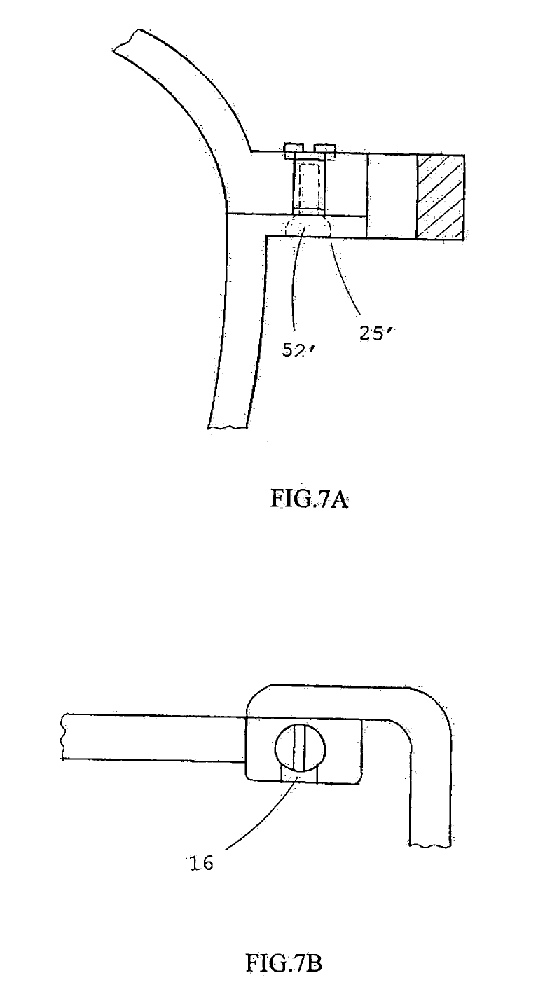

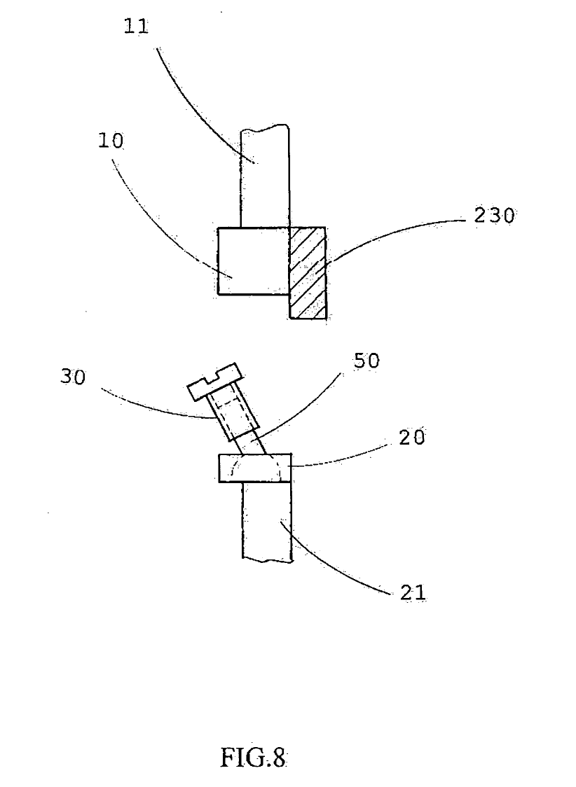

FIGS. 7A, 7B and 8 illustrate another embodiment of the present invention. The first hole 12 in the upper portion 10 has an open portion 16, the width of the open portion 16 is slightly larger than the diameter of the nut body 31, so that the locking nut 30 is able to swing in or out of the hole 12 in the upper portion 10. The second hole 22 in the lower portion 20 has a semi-spherical recess 25′ for matching the semi-spherical screw head 52′, so that the screw 50 can be pivotally swung back and forth. In addition, the locking nut 30 is firmly screwed into the screw 50, when the locking nut 30 is being swung into the hole 12 of the upper portion 10, and then rotates in clockwise direction, the upper portion 10 and the lower portion 20 will come close together. As the locking nut 30 has been tighten up, the rim will close. On the other hand, when the locking nut 30 is being rotated in counterclockwise direction, the upper portion 10 and the lower portion 20 will become loose, so that the locking nut 30 will be able to swing out from the hole 12 of the upper portion 10, then the frame will open. Therefore the lens can be removed or replaced.

It is to be noted that the major advantage on this design is the upper portion 10 and the lower portion 20 can be completely taken apart without separating the locking nut 30 off the screw 50, so as to prevent possibility of losing the screw during dispensing of the glasses.

In general, lens-lockers are connected either between the end piece and the rim (as shown in Prior Art (A)) or between the rim and the bridge of the frame (not shown), but in actual practice, especially for aesthetic purposes, lens-lockers can be placed in any cut-off locations of the rim so long as concealing behind the visible components thereby.

While the present invention has been described in certain levels of profundity, the above preferred embodiments are for purposes of the disclosure only, various changes in the detailed construction and arrangement of parts can be made by those skills in the art. However, it is to be understood that such changes are within the spirit and scope of the present invention, as defined by the following claims.

Detailed Description of the Third Preferred Embodiment

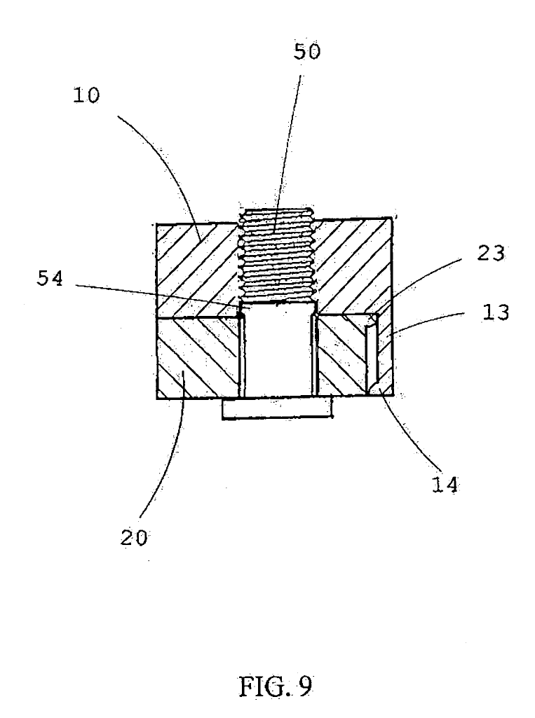

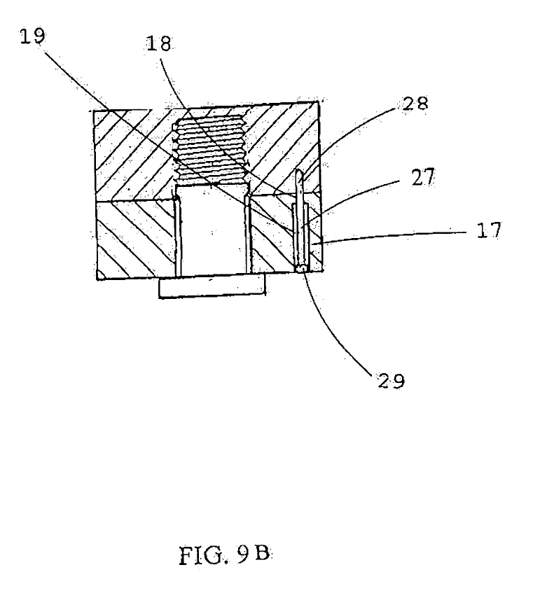

Referring to FIG. 9 of the drawing, a lens-locker comprises an upper portion 10 and a lower portion 20 which is connected by a screw 50. The upper portion 10 having a limitation-tail 13 extended toward the lower portion 20 with a hook 14 for reaching a limitation-stop 23 of the lower portion 20 when the screw 50 is being rotated in releasing direction so that to prevent the screw 50 slides off from the upper portion during the opening operation. It is to be noted that screw 50 having a screw neck 54 which is slightly larger than the hole of the lower portion 20 so as to ensure the screw 50 can be stayed in the lower portion 20 permanently and rotated freely, and also it is to be noted that the method of assembly of the screw 50 to the lower portion 20 should be in such circumstance while the lower portion is being heated.

Instead of having a limitation-tail and a limitation-stop in FIG. 9, the limitation-pin 27 has been introduced in this design as shown in FIG. 9B. The lower portion 20 further has a two-step hole 17 which includes a first step hold 19 and a second step hold 18 for inserting a limitation-pin 27. The limitation-pin 27 includes a pin-head 29 and a pin-body 28, in which the diameter of the pin-head 29 is slightly smaller than the diameter of the first step hole 19 and the diameter of the pin-body 28 is slightly smaller than the diameter of the second step hole 18, so that the limitation-pin 27 can go through the two-step hole 17 then connected to the upper portion 10. When the lens-locker is being opening, the limitation-pin 27 can be moving through the two-step hole 27 until the pin-head 29 being stopped by the second-step hole 18, in which the lens-locker is in maximum open position.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A lens-locker for spectacle frame, which connected to the rim in cut-off locations, comprising;
a first portion being connected to one end of cut-off lens rim having a hole for inserting a locking nut thereinto; said locking nut comprising a nut body and a nut head, when said locking nut is inserted into said hole of said first portion, a limitation washer fastens said nut body so that said locking nut is adapted to be rotated freely; and
a second portion being connected to the other end of cut-off lens rim having a screw for screwing into said locking nut, wherein when said locking nut rotates in clockwise (counterclockwise) direction causing said first portion engaging with said second portion, said frame is closed for retaining said lens therewithin; when said locking nut rotates in opposite direction, said first portion is moved apart from said second portion such that said frame is opened for allowing said lens to be detached therefrom.

2. The lens-locker, as recited in claim 1, wherein said first portion further having a limitation-tail extended toward said second portion which having a limitation-stop for preventing said screw of said second portion separates off from said locking nut when said frame opens.

3. The lens-locker, as recited in claim 1, wherein said first portion further having a two-step hole for inserting a limitation-pin being connected to said second portion so that when the lens-locker is being opening, said limitation-pin can be moving through said two-step hole until a pin-head of said limitation-pin being stopped by a second-step hole of said two-step hole, in which the lens-locker is in maximum open position.

4. The lens-locker, as recited in claim 1, wherein said lens rim is made of metal, plastic or nylon.

5. The lens-locker, as recited in claim 4, wherein said first portion further having a recess on outer end of said hole for seating said nut head when said locking nut has been inserted into said hole of said first portion.

6. The lens-locker, as recited in claim 5, wherein said locking nut further having a groove around said nut body and said limitation-washer further having broken ends so that said limitation-washer can be easily mounted on said groove of said nut body for preventing said locking nut slides off from said first portion.

7. The lens-locker, as recited in claim 6, wherein said second portion and said screw are separate components; said second portion further having a hole for inserting said screw; said screw having a hole for inserting a pin to prevent said screw sliding off from said second portion.

8. The lens-locker, as recited in claim 2, wherein said first portion is an upper portion of the lens-locker and said second portion is a lower portion of the lens-locker.

9. The lens-locker, as recited in claim 3, wherein said first portion is an upper portion of the lens-locker and said second portion is a lower portion of the lens-locker.

10. The lens-locker, as recited in claim 2, wherein said first portion is a lower portion of the lens-locker and said second portion is an upper portion of the lens-locker.

11. The lens-locker, as recited in claim 3, wherein said first portion is a lower portion of the lens-locker and said second portion is an upper portion of the lens-locker.

12. A lens-locker for spectacle frame, which connected to the rim in cut-off locations comprising;
a first portion being connected to one end of cut-off lens rim having a first hole with an open side for a locking nut be able to swing in and out; said locking nut comprising a nut body and a nut head; and
a second portion being connected to the other end of cut-off lens rim having a second hole for inserting a screw; said screw including a screw body and a screw head, as said screw being inserted into said second hole of said second portion and screwing into said nut body, said locking nut be able to swing back and forth for holding said second portion in place, wherein when said locking nut rotates in clockwise (counterclockwise) direction causing said first portion engaging with said second portion, said frame is closed for retaining said lens therewithin; when said locking nut rotates in opposite direction, said first portion is moved apart from said second portion such that said frame is opened for allowing said lens to be detached therefrom.

13. The lens-locker, as recited in claim 12, wherein said lens rim are made of metal, plastic or nylon.

14. The lens-locker, as recited in claim 13, wherein said first portion further having a recess on outer part of said first hole for seating said nut head when said locking nut is being swung into said first hole of said first portion.

15. The lens-locker, as recited in claim 14, wherein said second portion further having a semi-spherical recess on outer part of said second hole and said screw head having a semi-spherical head for corresponding said sphere recess when said screw is being inserted into said second hole of said second portion, so that said screw can be pivotally swung back and forth.

16. A lens-locker for spectacle frame, which connected to the rim in cut-off locations comprising;
a first portion and a second portion; said first portion having a limitation-tail extended toward said second with a hook; said second portion having a limitation stop for preventing said screw slides off from said first portion when said screw is being rotated in releasing direction for opening.

17. The lens-locker, as recited in claim 16, wherein said screw further having a screw neck which is slightly larger than the hole of said second portion so as to ensure said screw can be stayed in said second portion permanently and rotated freely.

18. A lens-locker for spectacle frame, which connected to the rim in cut-off locations comprising;
a first portion and a second portion; said first portion having a two-step hole for inserting a limitation-pin being connected to said second portion; when said lens-locker is being opening, said limitation-pin can be moving through said two-step hole until a pin-head of said limitation-pin being stopped by a second-step hole of said two-step hole, in which the lens-locker is in maximum open position.

19. The lens-locker, as recited in claim 19, wherein said screw further having a screw neck which is slightly larger than the hole of said second portion so as to ensure said screw can be stayed in said second portion permanently and rotated freely.
